(19) United States
(12) Patent Application Publication
(10) Pub. No.: US 2024/0019896 A1
(43) Pub. Date: Jan. 18, 2024

(54) WEARABLE ELECTRONIC DEVICES AND RELATED METHODS

(71) Applicant: Shopify Inc., Ottawa (CA)

(72) Inventor: Sanjiv Sirpal, Oakville (CA)

(21) Appl. No.: 17/864,141

(22) Filed: Jul. 13, 2022

(51) Int. Cl. G06F 1/16; H04B 1/3888

(52) U.S. Cl. CPC G06F 1/163; G06F 1/1686; H04B 1/3888; G06F 2200/1614

(57) ABSTRACT

Wearable electronic devices and related methods are disclosed. An example wearable electronic devices includes a first strap portion, a second strap portion, and a third strap portion, the first strap portion, the second strap portion, and the third strap portion being substantially rigid and defining a substantially triangular strap sized to receive an arm of a wearer; and a display screen carried by the first strap portion.

### FIELD OF THE DISCLOSURE

This disclosure relates generally to electronic devices and, more particularly, to wearable electronic devices and related methods.

### BACKGROUND

An employee at, for instance, a store or warehouse, may carry a mobile electronic device to assist the employee with performing tasks, such as identifying a location of inventory in a warehouse and retrieving the inventory for the order.

### BRIEF DESCRIPTION OF THE DRAWINGS

FIG. 1 illustrates an example wearable electronic device in accordance with teachings of this disclosure.

FIG. 2 illustrates the example wearable electronic device of FIG. 1 when worn by a user.

FIGS. 3-5 include additional views of the example wearable electronic device of FIG. 1.

FIG. 6 illustrates another example wearable electronic device in accordance with teachings of this disclosure.

FIG. 7 illustrates another example wearable electronic device in accordance with teachings of this disclosure.

FIG. 8 illustrates a strap of example wearable device in accordance with teachings of this disclosure.

FIG. 9 is a block diagram of an example wearable electronic device in accordance with teachings of this disclosure.

FIG. 10 is a flowchart of an example method to assemble the example wearable electronic device of FIGS. 1-7 in accordance with teachings of this disclosure

FIG. 11 a flowchart representative of example machine readable instructions and/or example operations that may be executed by example processor circuitry to control presentation of content on a display screen of the example wearable electronic devices of FIGS. 1-7.

FIG. 12 is a block diagram of an example processing platform including processor circuitry structured to implement one or more components of the example wearable electronic device of FIG. 9.

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

A user such as an employee of a store or warehouse may carry a mobile electronic device such as a scanner, a point-of-sale device, a label printer, an electronic tablet, etc. to facilitate completion of a task. For example, the user may carry the mobile electronic device to a location in the warehouse where a product is stored to retrieve the product to fulfill an order. When the user arrives at the storage location, the user may use the mobile electronic device to scan a barcode associated with the product to indicate that the order or a portion thereof has been fulfilled. In some instances, the user may need to use both hands to perform the task, such as carrying the product away from a storage area to an order packing area.

In some examples, the user may wish to place the mobile electronic device on a surface to interact with the device while performing a task. For instance, the user may wish to place the device on a surface such as a table to view a display screen of the device while counting inventory and entering corresponding data via a graphical user interface presented on the device.

Disclosed herein are example wearable electronic devices and mounts for electronic devices that provide for hands-free carrying of the device and that maintain a selected orientation of the device when the device is resting on a surface (e.g., a table) to facilitate ease of use of the device when not being worn. Example wearable electronic devices disclosed herein may be carried by an arm (e.g., a wrist, a forearm) of a user to enable the user to have free use of both hands while carrying the device. In some example devices disclosed herein, a display screen is supported by a strap that may be coupled to (e.g., slid over, fastened to) the user's arm.

As mentioned above, in some examples, the user may wish to place the electronic user device on a surface to interact with the device instead of interacting with the device while wearing the device. Disclosed example wearable electronic device maintains a selected orientation of the device when placed on a surface. Examples electronic devices disclosed herein have form factors that prevent the device from, for instance, falling or rolling to an orientation that could cause the user to have difficulty interacting with the device. For example, the device can remain substantially upright when the device is resting on a table (e.g., does not tip over). Also, the device can maintain a viewing angle of the display screen while resting on a surface to facilitate ease of viewing content on the screen. Examples electronic devices disclosed herein have form factors that prevent the device from rolling or falling to one side, which could cause the display screen to tilt rather than remain upright. For example, a shape and/or rigidity of a strap of the device can support the display screen in a selected orientation (e.g., portrait mode, landscape mode) when the device is placed on a surface. The orientation of content presented by the display screen can be selected automatically (e.g., based on orientation sensor(s) of the device) or manually.

Some example wearable electronic devices disclosed herein include hardware devices and/or electronic components such as a display screen, processor circuitry, etc. integrally formed with a wearable strap. Other examples disclosed herein can include a wearable strap to removably receive an electronic device.

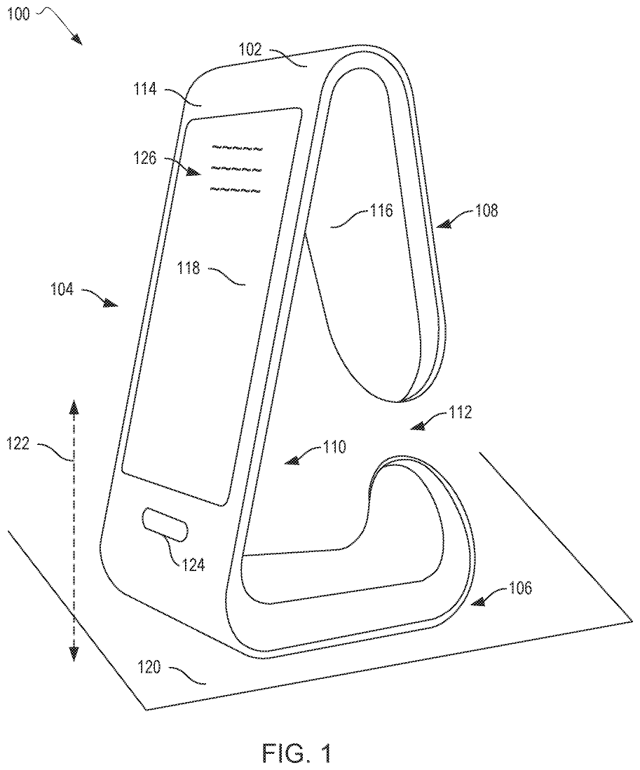

FIG. 1 illustrates an example wearable electronic device 100 in accordance with teachings of this disclosure. In particular, FIG. 1 is a front, right view of the example wearable electronic device 100. The wearable electronic device 100 includes a strap 102. The strap 102 can serve as a wristband or an armband when the wearable electronic device 100 is worn by a user.

The strap 102 of the example wearable electronic device 100 of FIG. 1 includes a first strap portion 104, a second strap portion 106, and a third strap portion 108. As illustrated in FIG. 1, the first strap portion 104 is disposed at an angle (e.g., an acute angle) relative to the second strap portion 106. Also, the third strap portion 108 is disposed at an angle (e.g., an acute angle) relative to the first strap portion 104 and the second strap portion 106. As illustrated in FIG. 1, the strap portions 104, 106, 108 define a substantially triangular shape of the strap 102. In some examples, the strap portions 104, 106, 108 are substantially flat. In some examples, one or more areas the respective strap portions 104, 106, 108 can include protrusions, indentations, etc.

In the example of FIG. 1, each of the strap portions 104, 106, 108 has a different length. Thus, the substantially triangular shape of the example strap 102 of FIG. 1 has a shape other than an equilateral triangular. However, in other examples, two or more of the strap portions 104, 106, 108, have the same or substantially the same length. Also, strap 102 can have other shapes, such as a parallelogram shape, a circular shape, etc.

In some examples, the first strap portion 104, the second strap portion 106, and the third strap portion 108 are one piece. In some examples, the portions 104, 106, 108 are defined by two or more pieces coupled together. In some examples, the strap portions 104, 106, 108 are movable relative to each other to adjust the angles between the portions. For instance, the strap 102 can include a hinge (e.g., a friction hinge) disposed between the first strap portion 104 and the second strap portion 106 to enable the angle between the first strap portion 104 and the second strap portion 106 be adjusted. The strap 102 can include a hinge (e.g., a friction hinge) between the first strap portion 104 and the third strap portion 108 to enable the angle between the first strap portion 104 and the third strap portion 108 be adjusted. The angles between the strap portions 104, 106, 108 can be adjusted to, for instance, adjust a size of the strap 102 for wearing, place the device 100 in a configuration for storage (e.g., a substantially flat configuration for laying or hanging), etc. As shown in FIG. 1, the strap 102 includes rounded portions (e.g., corners) between the portions 104, 106, 108 to avoid edges that may be uncomfortable when a user wears the strap 102.

When the example wearable device 100 of FIG. 1 is worn by a user, a portion of the user's arm (e.g., wrist, forearm) is disposed in an opening 110 defined by the strap 102. In the example of FIG. 1, a gap 112 is defined between the second strap portion 106 and the third strap portion 108 such that the strap 102 is partially open. The gap 112 of the strap 102 can provide flexibility in a size of the strap to accommodate users having different sized arms. In other examples, the strap 102 can be removably secured between the first strap portion 104 and the third strap portion 108. For instance, the strap 102 can include fasteners to secure the second strap portion 106 and the third strap portion 108. In other examples, the strap portions 104, 106, 108 define an integral strap (i.e., a strap without openings or fasteners between the strap portions 104, 106, 108).

The example strap 102 of FIG. 1 can include rigid, semi-rigid, and/or malleable materials such as plastic(s), rubber(s), flexible memory shape material, etc. In some examples, an outer surface 114 of the strap 102 (i.e., the surface extending along the exterior of the strap portions 104, 106, 108) includes a plastic material to support, cover, or house electronic components of the device 100 and to protect the components from damage due to liquids, damage due to dropping the device, etc. In some examples, at least a portion of an inner surface 116 of the strap 102 (i.e., the surface extending along the inner side strap portions 104, 106, 108 opposite the outer surface 114) can include cushioning or fabric to provide for comfort when the user's arm contacts the inner surface 115. The cushioning or fabric can extend across all or some of the inner surface 116 of the strap portions 104, 106, 108.

The example wearable electronic device 100 of FIG. 1 includes a display screen 118 viewable via the outer surface 114 of the strap 102. The display screen 118 can be, for instance, a touch screen, an e-ink display, etc. In the example of FIG. 1, the display screen 118 is carried by the first strap portion 104 of the strap 102. However, the display screen 118 could be carried by other portions of the strap 102. Also, as disclosed herein, the wearable electronic device 100 could include (e.g., house, removably carry) other display screens and/or electronic user devices.

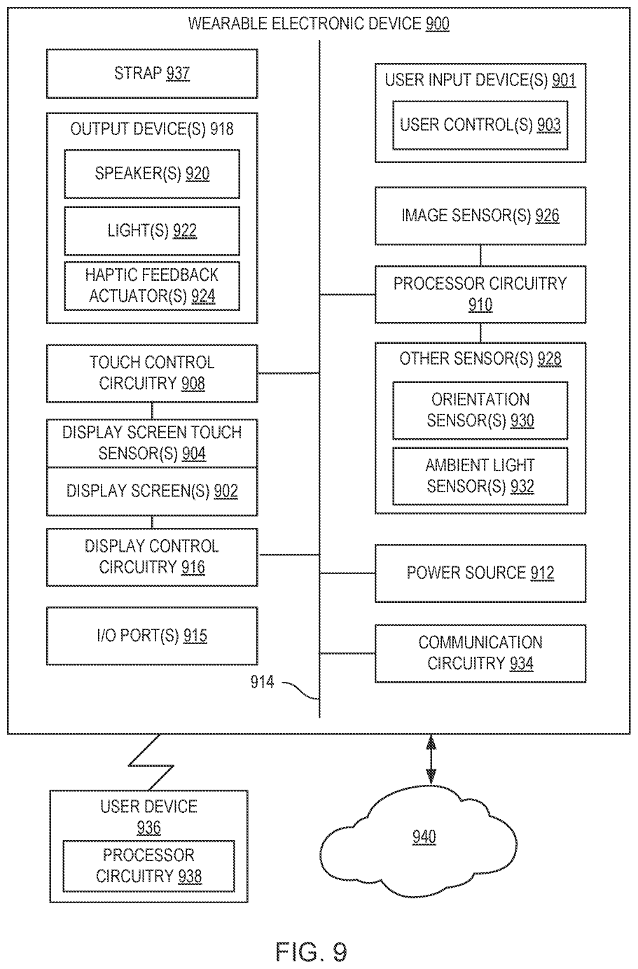

As disclosed herein, the wearable electronic device 100 of FIG. 1 includes processor circuitry 910 (FIG. 9) carried by the strap 102 to cause content (e.g., graphical user interface content) to be displayed on the display screen 118 and to respond to user inputs received at the device 100. The wearable electronic device 100 includes a power source 912 (FIG. 9) to provide power to the processor circuitry 910, the display screen 118, and other electronic components of the device 100.

In some examples, the wearable electronic device 100 includes light(s) 124 to provide alert(s) or indicators to a user of the device 100 with respect to, for instance, whether or not the device is powered on, a charging state of the device 100, etc. In the example of FIG. 1, the light(s) 124 are shown as a light bar disposed proximate to the display screen 118 on the first strap portion 106. The light(s) 124 could be located elsewhere on the strap 102. Additionally or alternatively, one or more user controls (e.g., button(s)) for operating the device 100 could be located on the first strap portion 104 (e.g., in place of or in addition to the light bar) and/or at other locations of the strap 102.

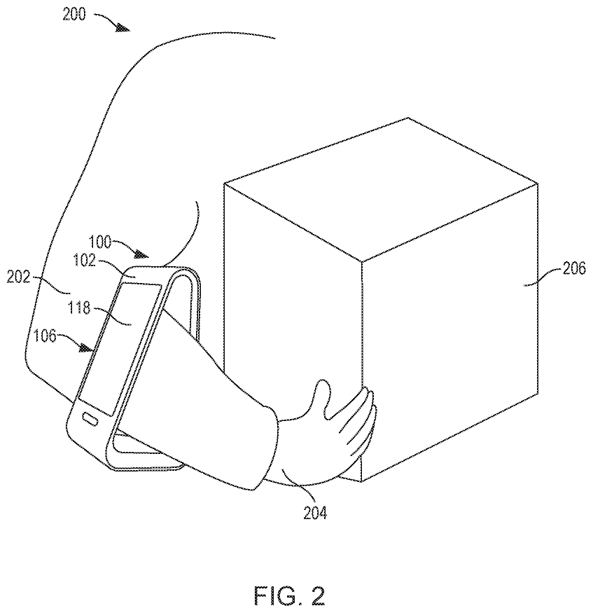

FIG. 2 shows the example wearable electronic device 100 of FIG. 1 when worn by a user 200. The strap 102 of the wearable electronic device 100 can be worn about an arm 202 of the user 200. As shown in FIG. 2, when wearing the device 100, a hand 204 of the user 200 associated with the arm 202 is free to perform other tasks such as to assist with carrying a box 206. A position and/or orientation of the wearable electronic device 100 relative to the arm 202 of the user 200 can differ from the example shown in FIG. 2. For instance, in some examples, the wearable device 100 can be worn with the first strap portion 104 and, thus, the display screen 118, disposed on a side of the arm 202 opposite the side shown in FIG. 2 (e.g., the inside of the arm rather than the outside of the arm).

Referring again to FIG. 1, the wearable electronic device 100 can be placed on a surface such as a table and maintain an orientation that facilitates use of the device while resting on the surface. In FIG. 1, the wearable electronic device 100 is shown in a first, or substantially upright orientation while resting a surface 120. As shown in FIG. 1, in the first orientation, at least a portion of the second strap portion 106 rests on the surface 120. The second strap portion 106 supports the first strap portion 104 and the third strap portion 108 extending above second strap portion 106. Thus, in the first orientation, the second strap portion 106 is in contact with the surface 120, however, the first strap portion 104 and the third strap portion 108 are not in contact with the surface 120 (or, in some instances, a substantial portion of the first strap portion 104 is not in contact with the surface 120).

In particular, when the wearable electronic device 100 is in the first orientation shown in FIG. 1 (e.g., the substantially upright position), the second strap portion 106 supports the first strap portion 104 such that the display screen 118 is disposed at a viewing angle to facilitate ease of viewing content the display screen 118. For example, the first strap portion 104 can be disposed at an angle of 13° to 15° relative to an axis 122 extending perpendicular to the surface 120 to provide a viewing angle for the display screen 118. As disclosed above, the angle of the first strap portion 104 relative to the second strap portion 106 and, thus, the axis 122, can be adjusted. Thus, the viewing angle of the display screen 118 carried by the first strap portion 104 can be adjusted. For example, the strap 102 can include a friction hinge disposed between the first strap portion 104 and the second strap portion 106 to enable the angle of the first strap portion 104 to be adjusted to change the viewing angle of the display screen 118. When the wearable electronic device 100 is in the first orientation of FIG. 1 (e.g., the substantially upright orientation), content 126 on the display screen 118 can be presented in a portrait view.

To facilitate support and use of the wearable electronic device 100 in the orientation of FIG. 1 (e.g., a substantially upright position), the strap portions 104, 106, 108 can include a rigid or substantially rigid material to enable the device 100 to remain in the first orientation. Also, the electronic components of the device 100 can be selectively distributed along the strap 102 to enable the device 100 to remain in the substantially upright orientation of FIG. 1. The distribution of the components relative to the strap 102 based on, for instance, weight of the components, can prevent the device 100 from becoming unstable (e.g., top-heavy) when in the substantially upright position of FIG. 1. For example, because the power source 912 (FIG. 9, e.g., a battery) may weigh more than, for instance, a printed circuit board associated with the processor circuitry 910 (FIG. 9), the power source 912 can be carried by the second strap portion 106. As a result, the stability of the electronic device 100 in the first orientation of FIG. 1 is increased to prevent, for example, the device 100 from falling over because the weight of the device 100 is substantially disposed in the base (i.e., second strap portion 106) of the device 100.

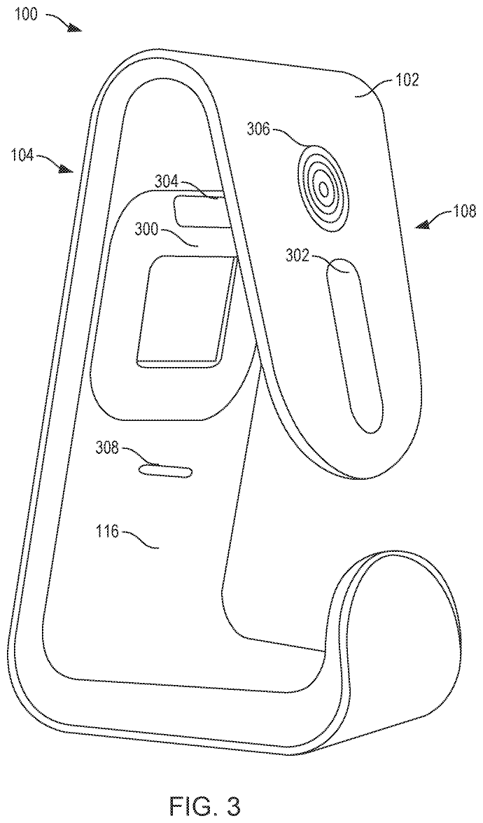

FIG. 3 is a right, rear view of the example wearable electronic device 100 of FIG. 1. In the example of FIG. 3, a portion of the inner surface 116 of the strap 102 that extends along the first strap portion 104 includes a cushion 300 to provide ergonomic support for a user when wearing or holding the device 100. In some examples, the cushion 300 is located for gripping by a hand of the user when, for instance, the user is operating an image sensor (FIG. 3, e.g., a camera, a scanner) of the device 100. The cushion 300 can have a different size and/or shape than the example shown in FIG. 3. The cushion 300 can include one or materials, can be textured, etc. The strap 102 can include additional cushions 300. Also, the cushion(s) 300 can be located elsewhere on the strap 102 than shown in FIG. 3 (e.g., on the first and third strap portions 104, 108).

In the example of FIG. 3, the third strap portion 108 supports image sensor(s) 302 (e.g., camera(s), a scanner) of the device 100. The image sensor(s) 302 can be used to, for instance, capture image(s) of an environment in which the wearable electronic device 100 is located, scan barcodes or documents, etc. The wearable electronic device 100 includes user control(s) 904 (FIG. 9) to control one or more components of the device 100. For instance, in the example of FIG. 3, an image sensor control button or trigger 304 is operatively coupled to the image sensor(s) 302 to activate the image sensor(s) 302. As shown in FIG. 3, the image sensor control button or trigger 304 can be supported by the inner surface 116 of the first strap portion 104 to enable ease of access to the button or trigger 304 when, for instance, the user is holding device 100 with his or her hand wrapped around the first strap portion 104 and directing the image sensor(s) 302 at object(s) in the environment to capture.

In some examples, the third strap portion 108 includes a near field communication (NFC) tag 306 to enable the wearable electronic device 100 to wirelessly communicate with other devices in the environment. For instance, the NFC tag 306 of the device 100 can be used to unlock a lock of a door in a warehouse. In some examples, the NFC tag 306 can facilitate communication with other electronic devices 100 (e.g., a smartphone, another wearable electronic device 100). A location of the NFC tag 306 on the strap 102 can differ from the example shown in FIG. 3.

The wearable electronic device 100 includes one or more input/output (I/O) ports to receive cables such as a universal serial bus (USB) cable for charging the device 100, for transferring data to or from the device 100, etc. In the example of FIG. 3, an I/O port 308 is located on the inner surface 116 of the first strap portion 104. However, the port(s) 308 could be located elsewhere on the strap 102 than the example shown in FIG. 3.

Although the examples of FIGS. 1 and 3 show the wearable electronic device 100 in the first orientation, or the substantially upright orientation, the wearable electronic device 100 can rest on the surface 120 in different orientations that also facilitate ease of use of the device 100 while on the surface 120. FIG. 4 shows the example wearable electronic device 100 of FIGS. 1-3 in a second orientation on the surface 120 different than the first or substantially upright orientation of FIGS. 1 and 3. As illustrated in FIG. 4, in the second orientation, the wearable electronic device 100 is disposed such that a first edge 400 that extends along the first, second, and third strap portions 104, 106, 108 (i.e., a longitudinal edge of the strap 102) rests on the surface 120. Thus, in the second orientation, at least a portion of each of the first, second, and third strap portions engages or is in contact with the surface 120. In other examples, the wearable electronic device 100 can rest on a second edge 402 of the strap 102 opposite the edge 400.

When the wearable electronic device 100 is in the second orientation of FIG. 4, the display screen 118 is disposed in a horizontal configuration relative to a viewpoint of a user looking at the display screen 118 (as compared to the vertical orientation of the display screen 118 in the first orientation of FIGS. 1 and 3). In the second orientation, the content 126 on the display screen 118 can be presented in a landscape view. Thus, in some instances herein, the second orientation of FIG. 4 will be referred to as a landscape orientation.

In some examples, the first strap portion 104 is disposed at an angle when in the second orientation of FIG. 4 to provide for a viewing angle of the display screen 118. For example, portion(s) of the edge(s) 400, 402 of the strap 102 can be tapered along the second strap portion 106 and the third strap portion 108. As a result of the tapered edge(s) 400, 402, the first strap portion 104 and, thus, the display screen 118, can rest at angle relative to the axis 122 extending perpendicular to the surface 120. In particular, at least a portion of the first strap portion 104 can be tilted away from the axis 122.

FIG. 5 illustrates the wearable electronic device 100 in a third orientation on the surface 120 different than the first orientation of FIGS. 1 and 3 (i.e., the substantially upright orientation) and the second orientation of FIG. 2 (i.e., the landscape orientation). In the example of FIG. 5, the wearable electronic device 100 is prone such that at least portion of the third strap portion 108 and at least a portion of the second strap portion 106 rest on the surface 120. In some examples, a grater portion of the third strap portion 108 is in contact with the surface 120 than the second strap portion 106. As shown in FIG. 5, the first strap portion 104 is elevated relative to the surface 120 in the third orientation. Thus, in the first orientation of FIGS. 1 and 3 and the third orientation of FIG. 5, the first strap portion 104 is elevated relative to the second strap portion 106.

In the example of FIG. 5, the first strap portion 104 and is disposed at an angle to provide for a viewing angle of the display screen 118. As represented by arrows 500, 502 of FIG. 5, a distance between the first strap portion 104 and the surface 120 increases along a length of the first strap portion 104 toward the second strap portion 106. A size of the second strap portion 106 can be selected to prop a portion of the first strap portion 104 proximate to the second strap portion 104 relative to a portion of the first strap portion proximate to the third strap portion 108. When the device 100 is in the third orientation of FIG. 5, the content 126 on the display screen 118 can be presented in portrait mode to facilitate viewing of content by a user looking down at the device 100.

The example wearable electronic device 100 of FIG. 1 can include orientation sensor(s) 930 (FIG. 9) such as accelerometer(s) to detect an orientation of the device 100 when the device 100 is being worn and/or when the device 100 is resting on the surface 120. In some examples, the device 100 includes sensors such as proximity sensors or infrared sensors to detect if the device 100 is being worn. The processor circuitry 910 (FIG. 9) of the device 100 can cause a view of the content on the display screen 118 to be adjusted based on changes in the orientation of the device 100. For instance, the processor circuitry 910 can cause the view of the content on the display screen 118 to be presented in portrait mode when the device 100 is being worn as shown in FIG. 2 or when the device is in the substantially upright position of FIGS. 1 and 3. The processor circuitry can cause the presentation of the content on the display screen to switch to landscape mode based on signals output by the orientation sensor(s) 930 indicating that the orientation of the device 100 has changed to the second or landscape orientation of FIG. 4.

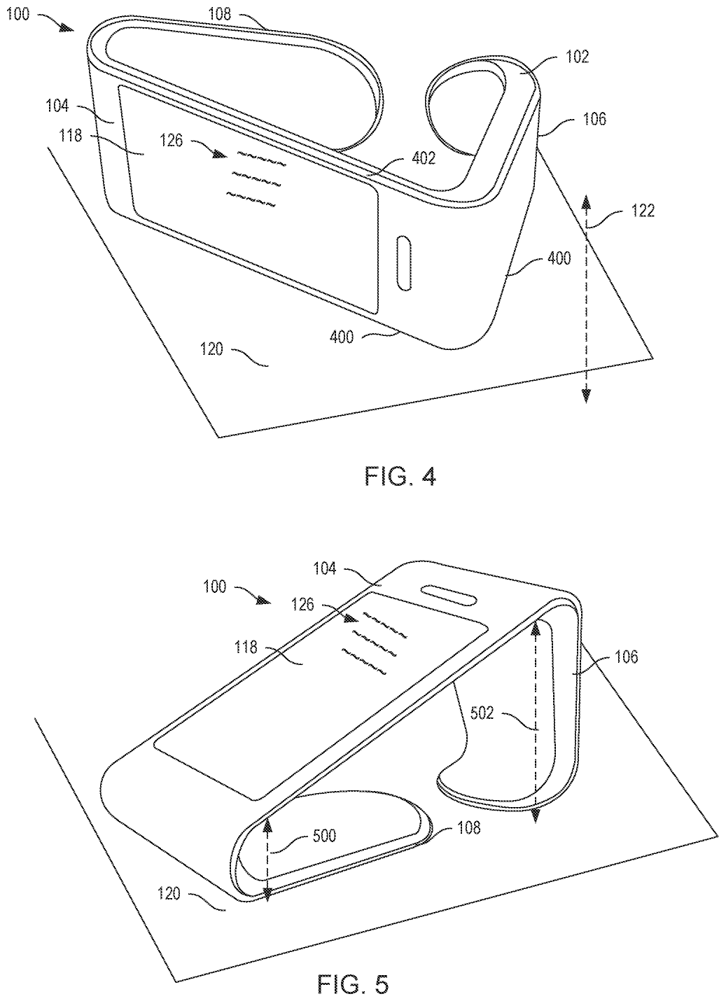

FIG. 6 illustrates another example wearable electronic device 600. The wearable electronic device 600 of FIG. 6 is substantially the same as the wearable electronic device 100 of FIGS. 1-5 but includes a second display screen 602 in addition to the display screen 118 on the first strap portion 104 (e.g., as shown in FIG. 1). In the example of FIG. 6, the second display screen 602 is carried by the outer surface 114 of the third strap portion 108 (in this example, the NFC tag 306 can be located elsewhere on the strap 102). However, the second display screen 602 could be located on other portions of the strap 102 (e.g., two display screens carried by the first strap portion 104). Also, although in FIG. 6, the device 600 includes a second display screen, the device 600 could additionally or alternatively include other electronic devices such as a printer or scanner.

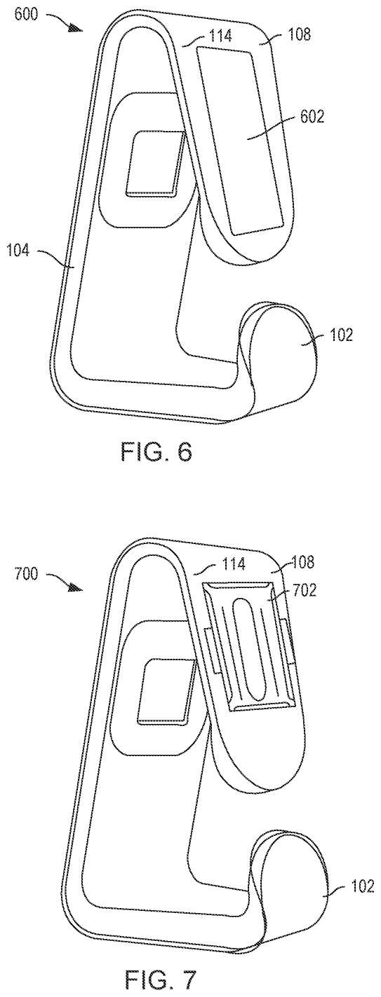

FIG. 7 illustrates another example wearable electronic device 600. The wearable electronic device 700 of FIG. 7 is substantially the same as the wearable electronic device 100 of FIGS. 1-5, however, the wearable electronic device 700 of FIG. 7 can support one or more other electronic devices removably coupled to the strap 102 of the device 700. In particular, the example wearable electronic device 700 of FIG. 7 includes a housing 702 (e.g., a sleeve) to removably receive an electronic device. The housing 702 can be made of, instance, fabric, rubber, plastic, and/or other materials. The electronic device can include, for instance, a scanner, a smartphone, etc. In some examples, the housing 702 can be used to store other items such as documents. In the example of FIG. 7, the housing 702 is coupled to the outer surface 114 of the third strap portion 108 (in this example, the NFC tag 306 can be located elsewhere on the strap 102). However, the housing 702 could be disposed at other portions of the strap 102. Also, the strap 102 can include more than one housing 702. The size, shape, and/or design of the housing 702 can differ from the examples shown in FIG. 7.

Although the example wearable electronic devices 100, 600, 700 of FIGS. 1-7 are disclosed as display devices, the wearable electronic devices 100, 600, 700 could include other types of devices that do or do not include a display screen. For example, the wearable electronic device 100 of FIGS. 1-5 could be a label printer or a scanner.

Also, although the example wearable electronic device 100, 600, 700 of FIGS. 1-7 include the electronic components such as the display screen 118, the light(s) 124, the images sensor(s) 302, etc., in other examples, the strap 102 does not include any electronic components. In such examples, the strap 102 can removably support an electronic device such as a smartphone but does not include any electronic components housed by or otherwise integrated with the strap.

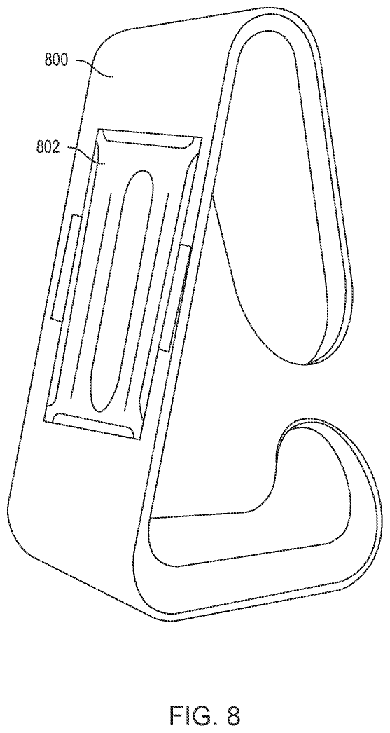

FIG. 8 illustrates an example strap 800 including a housing 802 to receive an electronic device. The housing 802 can include a sleeve or pocket to removably receive an electronic device such as a smartphone. The housing 802 can include fabric, rubber, plastic, and/or other materials. In some examples, at least a portion of the housing 802 includes a transparent material (e.g., a plastic) to enable the user to view and/or interact with the device while the device is disposed in the housing 802. In other examples, the housing 802 secures the device without substantially covering the device (e.g., without covering a display screen of a smartphone). The size, shape, design, and/or location of the housing 802 relative to the strap 800 can differ from the examples shown in FIG. 8.

FIG. 9 is a block diagram of an example wearable electronic device 900 (e.g., the wearable electronic device(s) 100, 600, 700 of FIGS. 1-7) in accordance with teachings of this disclosure. The example wearable device 900 includes user input device(s) 901 to enable a user to interact with the device 900. The user input device(s) 901 can include, for example, control(s) 903 (e.g., button(s), switch(es), trigger(s), etc. such as the image sensor control button 304 of FIG. 3) to control the device 900 (e.g., to power on or off the device 900, to activate a camera, etc.).

The example wearable device 900 includes a display screen 902. The display screen 902 can include an e-ink display, a liquid crystal display, etc. In the example of FIG. 9, the display screen 902 is a touch screen that enables a user to interact with data presented on the display screen 902 by touching the screen with a stylus and/or one or more fingers or a hand of the user. The example display screen 902 includes one or more display screen touch sensor(s) 904 that detect electrical changes (e.g., changes in capacitance, changes in resistance) in response to touches on the display screen 902. In some examples, the display screen touch sensor(s) 904 can include force sensor(s) that detect an amount of force or pressure applied to the display screen 902 by the user's finger or stylus. In some examples, the wearable electronic device 900 includes more than one display screen.

The example wearable electronic device 900 of FIG. 9 includes touch control circuitry 908 to process the signals output by the display screen touch sensor(s) 904 when the user touches the display screen 902. The touch control circuitry 908 interprets the signal data to identify particular locations of touch events on the display screen 902. The touch control circuitry 908 communicates the touch event(s) to, for example, processor circuitry 910 (e.g., a central processing unit) of the wearable electronic device 900. In some instances, the touch control circuitry 908 is implemented by the processor circuitry 910.

The processor circuitry 910 can include a central processing unit executing instructions. Additionally or alternatively, the processor circuitry 910 may be implemented by ASIC or an FPGA structured to perform operations corresponding to the instructions. It should be understood that some or all of the circuitry of FIG. 9 may, thus, be instantiated at the same or different times. Some or all of the circuitry may be instantiated, for example, in one or more threads executing concurrently on hardware and/or in series on hardware. Moreover, in some examples, some or all of the circuitry of FIG. 9 may be implemented by microprocessor circuitry executing instructions to implement one or more virtual machines and/or containers

The wearable electronic device 900 of FIG. 9 includes a power source 912 such as a battery to provide power to the processor circuitry 910 and/or other components of the device 900 communicatively coupled via a bus 914. The wearable electronic device 900 of FIG. 9 includes one or more input/output ports 915 (e.g., USB port(s), I/O port 308 of FIG. 3) to enable, for instance, a power cable to be coupled to the device 900 to charge the device 900, to transfer data to or from the device 900, etc.

The example wearable electronic device 900 of FIG. 9 includes display control circuitry 916 (e.g., a graphics processing unit (GPU)). The display control circuitry 916 controls operation of the display screen 902 and facilitates rending of content (e.g., display frame(s) associated with graphical user interface(s)) via the display screen 902. In some examples, the display control circuitry 916 is implemented by the processor circuitry 910.

The example wearable electronic device 900 includes one or more output devices 918 such as speaker(s) 920 to provide audible outputs to a user. In some examples, the output device(s) 918 include light(s) 922 (e.g., the light(s) 124 of FIG. 1) to provide indicator(s) or alert(s) to the user (e.g., that the device 900 is powered on, that the device 900 is charging, etc.). In some examples, the output device(s) 918 include haptic feedback actuator(s) 924 to provide haptic feedback or touch experiences to the user of the wearable electronic device 900 via vibrations, forces, etc. that are output in response to, for example, touch event(s) on the display screen 902 of the device 900. In such examples, the processor circuitry 910 can implement haptic feedback control circuitry to generate instructions for the haptic feedback actuator(s) 924.

The example wearable electronic device 900 of FIG. 9 includes image sensor(s) 926. The image sensor(s) 926 can include camera(s), scanner(s), etc. to generate image data. The wearable electronic device 900 can include other types of sensors 928. For example, as disclosed above, the device 900 can include orientation sensor(s) 930 (e.g., accelerometer(s), gyroscope(s)) to detect an orientation of the device 900. The processor circuitry 910 and/or the display control circuitry 916 can use analyze signals from the orientation sensor(s) 930 to control presentation of content on the display screen 902 (e.g., portrait mode, landscape mode). In some examples, the device 900 includes ambient light sensor(s) 932 to detect lighting conditions in an environment in which the device 900 is located. The processor circuitry 910 and/or the display control circuitry 916 can use analyze signals from the ambient light sensor(s) 932 to cause a brightness of the display screen 902 to be adjusted.

The example wearable device 900 of FIG. 9 includes communication circuitry 934 to enable the device 900 to communicate with other devices such as other wearable electronic devices 100, 600, 700, 900, other user device(s) 936 such as a smartphone, a personal computing device (e.g., a laptop), etc. The communication circuitry 934 can establish communicative coupling via wired or wireless communication protocols (e.g., Wi-Fi, Bluetooth®, near-filed communication via the NFC tag 306 of FIG. 3, etc.)

In the example of FIG. 9, the electronic components 901, 902, 903, 904, 908, 910, 912, 914, 915, 916, 918, 920, 922, 924, 926, 928, 930, 932, 934 are carried by a strap 937 (e.g., the strap 102 of FIGS. 1-7). The strap 937 can house or otherwise support the electronic components of the device 900 while enabling the user to wear the device 900.

Although shown as one device 900, some of the analysis performed by the processor circuitry of the device 900 could be implemented by, for instance, processor circuitry 938 of the other user device 936 (e.g., a smartphone, an edge device, etc.) in communication with the wearable electronic device 900 (e.g., via wired or wireless communication protocols), and/or by a cloud-based device 940 (e.g., one or more server(s), processor(s), and/or virtual machine(s)). These components may be implemented in software, in firmware, in hardware, or in any combination of two or more of software, firmware, and/or hardware. In some examples, the processor circuitry 910 is communicatively coupled to other processor circuitry on the device 900 and/or on other devices (e.g., a second user device 936, a cloud computing device accessible via the cloud 940, etc.). In such examples, the processor circuitry 910 can transmit data to and/or received data from, for instance, the cloud-based device 940 and/or the processor circuitry 938 of the second user device 936.

While an example manner of implementing the wearable electronic device 900 is illustrated in FIG. 9, one or more of the elements, processes, and/or devices illustrated in FIG. 9 may be combined, divided, re-arranged, omitted, eliminated, and/or implemented in any other way. Further, one or more of the elements, processes, and/or devices of the example wearable electronic device 900 of FIG. 9 may be implemented by hardware alone or by hardware in combination with software and/or firmware. Thus, for example, one or more of the example elements, processes, and/or devices of the example wearable electronic device 900 of FIG. 9 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example wearable electronic device 900 of FIG. 9 may include one or more elements, processes, and/or devices in addition to, or instead of, those illustrated in FIG. 9, and/or may include more than one of any or all of the illustrated elements, processes, and devices.

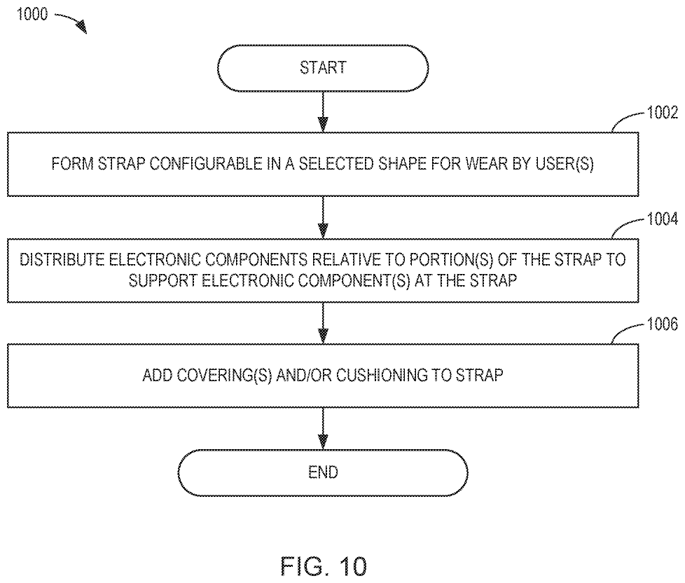

FIG. 10 is a flowchart of an example method 1000 to assemble a wearable electronic device such as the example wearable electronic device 100, 600, 700, 900 of FIGS. 1-7 and/or 9 in accordance with teachings of this disclosure. The method 1000 of FIG. 10 includes forming a strap that is configurable in a selected shape for wear by a user (block 1002). For example, the strap 102 of FIGS. 1-7 can be formed from rigid or semi-rigid materials to enable the strap 102 to be configured in a substantially triangular shape.

The method 1000 of FIG. 10 includes distributing electronic components relative to portion(s) of the strap to support the electronic components at the strap (block 1004). For example, the power source 912 (e.g., a battery) of the device 100, 600, 700, 900 can be disposed in the second strap portion 106 of the strap 102 of FIGS. 1-7 such that the power source 912 is disposed in the base of the device 100, 600, 700, 900 when the device 100, 600, 700, 900 is in the substantially upright orientation of FIGS. 1 and 3 (e.g., so the device 100, 600, 700, 900 is not top heavy). The display screen 118 can be disposed at the first strap portion 104 based on a size of the display screen 118, to facilitate ease of viewing, etc.

The method 1000 of FIG. 10 includes adding covering(s) and/or cushioning to the strap (block 1006). For example, the outer surface 114 of the strap 102 of FIGS. 1-7 can include a plastic or rubber housing to cover one or more electronic component(s) to protect the component(s) from liquid damage, damage from dropping the device 100, 600, 700, 900, etc. In some examples, cushion(s) 300 can be added to the inner surface 116 of the strap 102 to provide for comfort when wearing the strap 102.

Although the example method 1000 is described with reference to the flowchart illustrated in FIG. 10, many other methods of assembling a wearable electronic device may alternatively be used. For example, the order of execution of the blocks may be changed, and/or some of the blocks described may be changed, eliminated, or combined. Similarly, additional operations may be included in the example method of FIG. 10 before, in between, or after the blocks shown in FIG. 10.

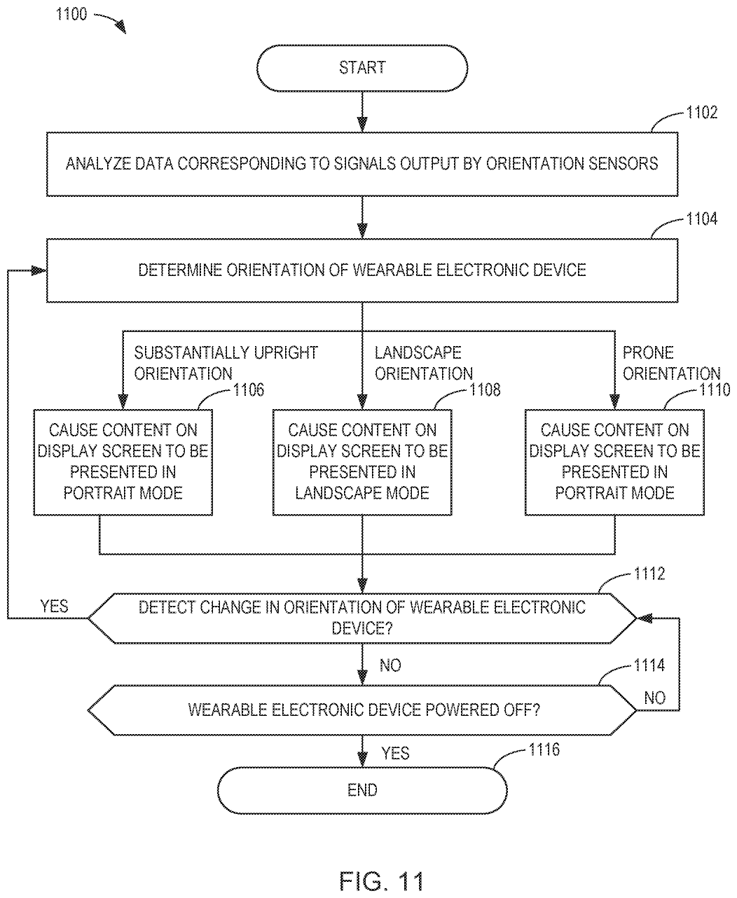

FIG. 11 is a flowchart representative of example machine readable instructions and/or example operations 1100 that may be executed and/or instantiated by processor circuitry to control presentation of content on the display screen 118 of the example wearable electronic devices 100, 600, 700 of FIGS. 1-7. The machine readable instructions and/or the operations 1100 of FIG. 11 begin at block 1102, in which the processor circuitry 910 of the wearable electronic device 100, 600, 700 analyzes data corresponding to signals output by the orientation sensor(s) 930 of the wearable electronic device 100, 600, 700. At block 1104, the processor circuitry 910 determines an orientation of the wearable device 100, 600, 700 based on the analysis of the signal data.

If the processor circuitry 910 determines that the device 100, 600, 700 is in the substantially upright orientation of FIGS. 1 and 3, then at block 1106, the processor circuitry 910 causes content on the display screen 118 to be presented in a portrait mode (e.g., by outputting instructions to the display control circuitry 916).

If the processor circuitry 910 determines that the device 100, 600, 700 and, thus the display screen 118, is in the substantially upright orientation of FIGS. 1 and 3, then at block 1106, the processor circuitry 910 causes content on the display screen 118 to be presented in a portrait mode (e.g., by outputting instructions to the display control circuitry 916). In some examples, the processor circuitry 910 determines that the device 100, 600, 700 is in the substantially upright mode while on the surface 120 or while being worn by the user.

If the processor circuitry 910 determines that the device 100, 600, 700 and, thus, the display screen 118, is in the landscape orientation of FIG. 4, then at block 1108, the processor circuitry 910 causes content on the display screen 118 to be presented in a landscape mode (e.g., by outputting instructions to the display control circuitry 916).

If the processor circuitry 910 determines that the device 100, 600, 700 and, thus, the display screen 118, is in the prone orientation of FIG. then at block 1110, the processor circuitry 910 causes content on the display screen 118 to be presented in the portrait mode (e.g., by outputting instructions to the display control circuitry 916).

At block 1112, the processor circuitry 910 determines a change in the orientation of the wearable device 100, 600, 700 and, thus, the display screen 118, has been detected based on signal data from the orientation sensor(s) 930. The example instructions 1100 end at blocks 1114, 1116 when the wearable electronic device 100, 600, 700 is powered off.

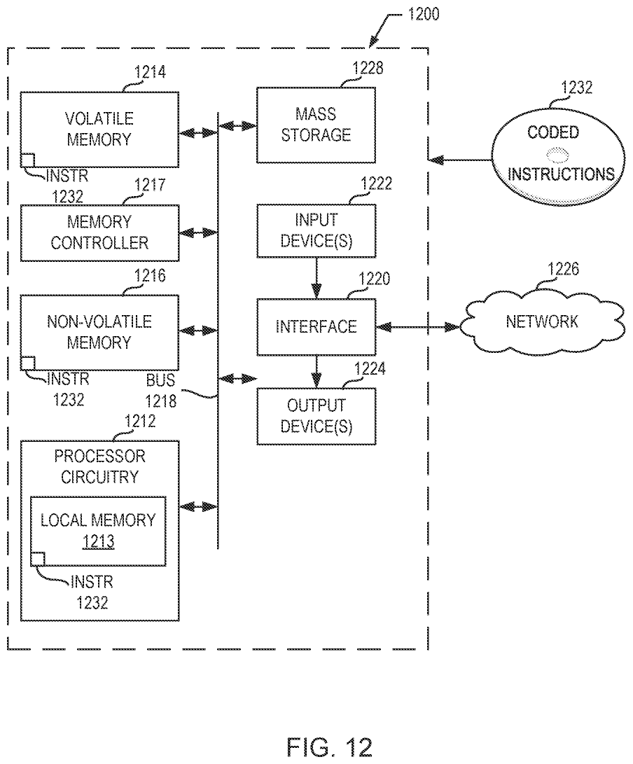

The flowchart of FIG. 11 is representative of example hardware logic circuitry, machine readable instructions, hardware implemented state machines, and/or any combination thereof for implementing the processor circuitry 910 of FIG. 9. The machine readable instructions may be one or more executable programs or portion(s) of an executable program for execution by processor circuitry, such as the processor circuitry 1212 shown in the example processor platform 1200 discussed below in connection with FIG. 12. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 11, many other methods of implementing the example processor circuitry 910 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 11 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 12 is a block diagram of an example processor platform 1200 structured to execute and/or instantiate the to implement the wearable electronic device 900 of FIG. 9 (e.g., the processor circuitry 910, the touch control circuitry 908, the display control circuitry 916, and/or the communication circuitry 934). The processor platform 1200 can be, for example, a personal computer, a mobile device (e.g., a cell phone, a smart phone, a tablet such as an iPad™), a personal digital assistant (PDA), an Internet appliance, a wearable device, or any other type of computing device.

The processor platform 1200 of the illustrated example includes processor circuitry 1212. The processor circuitry 1212 of the illustrated example is hardware. For example, the processor circuitry 1212 can be implemented by one or more integrated circuits, logic circuits, FPGAs, microprocessors, CPUs, GPUs, DSPs, and/or microcontrollers from any desired family or manufacturer. The processor circuitry 1212 may be implemented by one or more semiconductor based (e.g., silicon based) devices.

The processor circuitry 1212 of the illustrated example includes a local memory 1213 (e.g., a cache, registers, etc.). The processor circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217.

The processor platform 1100 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user to enter data and/or commands into the processor circuitry 1212. The input device(s) 1222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1200 of the illustrated example also includes one or more mass storage devices 1228 to store software and/or data. Examples of such mass storage devices 1228 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 1232, which may be implemented by the machine readable instructions of FIG. 11, may be stored in the mass storage device 1228, in the volatile memory 1214, in the non-volatile memory 1216, and/or on a removable non-transitory computer readable storage medium such as a CD or DVD.

From the foregoing, it will be appreciated that example systems, methods, apparatus, and articles of manufacture have been disclosed that provide for wearable electronic devices the provide for hands-free carrying of the device while also facilitating use of the device on a surface such as a table. Example wearable devices disclosed herein include a strap having substantially rigid portions that enable the device to maintain an orientation (e.g., a substantially upright orientation) when placed on a surface without a risk of, for instance, the device falling to one side. Examples wearable electronic devices disclosed herein can include display devices and/or other types of devices (e.g., scanners, printers) to facilitate ease of use of such devices in an environment in which users are mobile, such as a warehouse or store.

Example apparatus, systems, methods, and articles of manufacture for wearable electronic devices are disclosed herein. Further examples and combinations thereof include the following:

Example 1 includes a wearable electronic device comprising a first strap portion, a second strap portion, and a third strap portion, the first strap portion, the second strap portion, and the third strap portion being substantially rigid and defining a substantially triangular strap sized to receive an arm of a wearer; and a display screen carried by the first strap portion.

Example 2 includes the wearable electronic device of example 1, further including a power source carried by the second strap portion and communicatively coupled to the display screen.

Example 3 includes the wearable electronic device of examples 1 or 2, wherein the first strap portion is disposed between the second strap portion and the third strap portion.

Example 4 includes the wearable electronic device of any of examples 1-3, wherein the second strap portion is to support the first strap portion and the third strap portion with the display screen in a first orientation when at least a portion of the second strap portion rests on a surface, the third strap portion spaced apart from the second strap portion when the display screen is in the first orientation, the first strap portion and the third strap portion not engaged with the surface when the display screen is in the first orientation.

Example 5 includes the wearable electronic device of any of examples 1-4, wherein the first orientation is associated with a portrait mode of the display screen.

Example 6 includes the wearable electronic device of any of examples 1-5, wherein the second strap portion and the third strap portion are configured to support the display screen in a second orientation when at least a longitudinal edge of the second strap portion and the third strap portion rest on the surface.

Example 7 includes the wearable electronic device of any of examples 1-6, wherein the second orientation is associated with a landscape mode of the display screen.

Example 8 includes the wearable electronic device of any of examples 1-7, wherein the second strap portion or the third strap portion includes a slot to removably receive a second electronic user device.

Example 9 includes the wearable electronic device of any of examples 1-8, further including an image sensor carried by the third strap portion.

Example 10 includes a wearable wrist strap comprising a first strap portion including a housing to support a display screen; a second strap portion; and a third strap portion, the first strap portion, the second strap portion, and the third strap portion defining a triangular shape, the first strap portion disposed between the second strap portion and the third strap portion, the second strap portion to support the first strap portion and the third strap portion in a first strap orientation when at least a portion of the second strap portion rests on a surface, the first strap portion and the third strap portion extending above the second strap portion in the first strap orientation.

Example 11 includes the wearable wrist strap of example 10, wherein the housing is to removably receive the display screen.

Example 12 includes the wearable wrist strap of examples 10 or 11, wherein the third strap portion is moveable relative to the first strap portion to adjust an angle between the third strap portion and the first strap portion.

Example 13 includes the wearable wrist strap of any of examples 10-12, further including a gap defined between the third strap portion and the second strap portion.

Example 14 includes the wearable wrist strap of any of examples 10-13, wherein in a second strap orientation, an edge extending along the first strap portion, the second strap portion, and the third strap portion is to engage the surface.

Example 15 includes the wearable wrist strap of any of examples 10-14, wherein in a third strap orientation, at least a portion of the second strap portion and at least a portion of the third strap portion are to engage the surface, the first strap portion elevated relative to the surface in the third strap orientation.

Example 16 includes a wearable electronic device comprising a strap having a first strap portion, a second strap portion, and a third strap portion, the first strap portion, the second strap portion, and the third strap portion being substantially rigid, the first strap portion disposed at an angle relative to the second strap portion, the third strap portion disposed at an angle relative to the first strap portion and the second strap portion; a display screen carried by the first strap portion; and processor circuitry carried by the strap, the processor circuitry to cause an orientation of content presented on the display screen to be adjusted between (a) a first presentation mode when the first strap portion is elevated relative to the second strap portion and at least a portion the second strap portion is in contact with a surface and (b) a second presentation mode when an edge of the first strap portion is in contact with the surface.

Example 17 includes the wearable electronic device of example 16, wherein the angle between the first strap portion and the third strap portion is adjustable.

Example 18 includes the wearable electronic device of examples 16 or 17, further including a camera.

Example 19 includes the wearable electronic device of any of examples 16-18, wherein the camera is carried by the third strap portion and further including a camera control button carried by the first strap portion.

Example 20 includes the wearable electronic device of any of examples 16-19, further including an accelerometer to detect an orientation of the first strap portion.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The status of the claims:

1. A wearable electronic device comprising:
a first strap portion, a second strap portion, and a third strap portion, the first strap portion, the second strap portion, and the third strap portion defining a strap having a shape corresponding to at least a portion of a triangle, the strap sized to receive an arm of a wearer; and
a display screen carried by the first strap portion, wherein the second strap portion and the third strap portion support the first strap portion with the display screen in a first orientation when at least a portion of the second strap portion and at least a portion of the third strap portion rest on a surface, the portion of the third strap portion resting on the surface greater than the portion of the second strap portion resting on the surface, the first strap portion extending over the portion of the second strap portion and the portion of the third strap portion resting on the surface.

2. The wearable electronic device of claim 1, further including a power source carried by the second strap portion and communicatively coupled to the display screen.

3. The wearable electronic device of claim 2, wherein the first strap portion is disposed between the second strap portion and the third strap portion.

4. The wearable electronic device of claim 2, wherein the second strap portion supports the first strap portion and the third strap portion with the display screen in a second orientation when at least a portion of the second strap portion rests on the surface and the first strap portion and the third strap portion are not engaged with the surface.

5. The wearable electronic device of claim 4, wherein the first orientation and the second orientation are associated with a portrait mode of the display screen.

6. The wearable electronic device of claim 4, wherein the second strap portion and the third strap portion support the display screen in a third orientation when at least a longitudinal edge of the second strap portion and the third strap portion rest on the surface.

7. The wearable electronic device of claim 6, wherein the third orientation is associated with a landscape mode of the display screen.

8. The wearable electronic device of claim 1, wherein the second strap portion or the third strap portion includes a slot to removably receive a second electronic user device.

9. The wearable electronic device of claim 1, further including an image sensor carried by the third strap portion.

10. A wearable wrist strap comprising:
a first strap portion including a housing to support a display screen;
a second strap portion; and
a third strap portion, the first strap portion, the second strap portion, and the third strap portion defining a triangular shape, the first strap portion disposed between the second strap portion and the third strap portion,
the second strap portion to support the first strap portion and the third strap portion in a first strap orientation when at least a portion of the second strap portion rests on a surface, the first strap portion and the third strap portion extending above the second strap portion in the first strap orientation, and
the second strap portion and the third strap portion to support the first strap portion in a second strap orientation when at least a portion of the second strap portion and at least a portion of the third strap portion rest on the surface, the first strap portion extending at an incline over the portion of the second strap portion and the portion of the third strap portion that rest on the surface in the second strap orientation.

11. The wearable wrist strap of claim 10, wherein the housing removably receives the display screen.

12. The wearable wrist strap of claim 10, wherein the third strap portion is moveable relative to the first strap portion to adjust an angle between the third strap portion and the first strap portion.

13. The wearable wrist strap of claim 10, further including a gap defined between the third strap portion and the second strap portion.

14. The wearable wrist strap of claim 10, wherein in a third strap orientation, an edge extending along the first strap portion, the second strap portion, and the third strap portion engages the surface.

15. (canceled)

16. A wearable electronic device comprising:
a strap having a first strap portion, a second strap portion, and a third strap portion, the first strap portion disposed at an angle relative to the second strap portion, the third strap portion disposed at an angle relative to the first strap portion and the second strap portion;
a display screen carried by the first strap portion; and
processor circuitry carried by the strap, the processor circuitry to cause an orientation of content presented on the display screen to be adjusted between (a) a first presentation mode when the first strap portion is supported at an incline by the second strap portion and the third strap portion and at least a portion the second strap portion and at least a portion of the third strap portion are in contact with a surface, the portion of the second strap portion and the portion of the third strap portion in contact with the surface beneath the first strap portion, and (b) a second presentation mode when an edge of the first strap portion is in contact with the surface.

17. The wearable electronic device of claim 16, wherein the angle between the first strap portion and the third strap portion is adjustable.

18. The wearable electronic device of claim 16, further including a camera.

19. The wearable electronic device of claim 18, wherein the camera is carried by the third strap portion and further including a camera control button carried by the first strap portion.

20. The wearable electronic device of claim 16, further including an accelerometer to detect an orientation of the first strap portion.

21. The wearable electronic device of claim 1, wherein an end of the second strap portion and an end of the third strap portion define a gap therebetween.
